(19) United States
(12) Patent Application Publication
(10) Pub. No.: US 2025/0159047 A1
(43) Pub. Date: May 15, 2025

(54) Method and System for Registering a User to a Vehicle

(71) Applicant: Bayerische Motoren Werke Aktiengesellschaft, Muenchen (DE)

(72) Inventor: Markus Walter, Poecking (DE)

(21) Appl. No.: 18/835,900

(22) PCT Filed: Nov. 30, 2022
(86) PCT No.: PCT/EP2022/083787

§ 371 Date: Aug. 5, 2024

(30) Foreign Application Priority Data
Feb. 16, 2022 (DE) 10 2022 103 571.9

(51) Int. Cl. H04L 67/12; B60W 40/08

(52) U.S. Cl. CPC H04L 67/12; B60W 40/08; B60W 2040/0809; B60W 2040/0881

(57) ABSTRACT

A method and system for registering a vehicle is disclosed herein. The vehicle includes a seat, a mobile terminal with a seating position display, and a controller. The controller is configured to detect a mobile terminal belonging to a user of the vehicle, wherein the mobile terminal belonging to the user is detected using a wireless communication protocol. The controller is further configured to determine a seating position of the seat in the vehicle, and log in the user at the determined seating position in the vehicle by means of the vehicle.

### CROSS-REFERENCE TO RELATED APPLICATIONS

The present application is the U.S. national phase of PCT Application PCT/EP2022/083787 filed on Nov. 30, 2022, which claims priority of German patent application No. 10 2022 103 571.9 filed on Feb. 16, 2022, the entire contents of which are incorporated herein by reference.

### FIELD

The present disclosure relates to the field of motor vehicles, and particularly to a method and system for logging a user into a vehicle.

### BACKGROUND

In current vehicles, a user of the vehicle can input his login data via a display of the vehicle in order to log in in the vehicle. It is also known practice to make it possible to log in a user in a vehicle by recording a QR code displayed on a vehicle display by means of a camera of a mobile terminal. An interaction with a vehicle display is always required in the known prior art for logging the user into the vehicle.

In view of the foregoing, it would be advantageous to efficiently simplify log-in of a user in a vehicle. In particular, it would be advantageous to make it possible to log in all users, in particular all occupants, of a vehicle in a simpler and more precise manner. It would also be advantageous to efficiently automate log-in of a user in a vehicle.

### SUMMARY

According to a first aspect, the disclosure herein is distinguished by a method for logging a user into a vehicle. The method may be a computer-implemented method and/or a controller-implemented method. The user may be an occupant, a driver, a front-seat passenger and/or a rear-seat passenger of the vehicle. The method may log in the user without the user interacting with a display device (display) of the vehicle. In other words, the method for logging the user into the vehicle can be carried out independently of the user interacting with a display device of the vehicle. The user may log in in the vehicle using a mobile terminal brought into the vehicle by the user. The mobile terminal may be a smartphone, a smartwatch, smart glasses, a tablet and/or another mobile terminal belonging to the user. The vehicle may be a motor vehicle.

The method detects a mobile terminal belonging to the user, wherein the mobile terminal belonging to the user is detected using a wireless communication protocol. Furthermore, the method determines a seating position of the user in the vehicle. The method finally logs in the user at the determined seating position in the vehicle by means of the vehicle.

A user can advantageously log into the vehicle, and in particular at a specific seating position in the vehicle, without interacting with a display device of the vehicle, in particular with a display operating device of the vehicle. The mobile terminal and the seating position in the vehicle, at which the mobile terminal and the user are situated, can be determined in an automated manner. The method can therefore efficiently simplify the log-in of a user in the vehicle. A user can efficiently log in at a seating position in the vehicle using the mobile terminal even if this seating position does not have a display device or a display operating device.

According to a first advantageous configuration, the determination of the seating position of the user in the vehicle may comprise providing a vehicle-specific seating position display on the mobile terminal, wherein the vehicle-specific seating position display provides the user with one or more seating positions in the vehicle, receiving an operating interaction of the user with the vehicle-specific seating position display, wherein the operating interaction is representative of a seating position in the vehicle that is selected by the user, and transmitting the selected seating position from the mobile terminal to the vehicle. This makes it possible for the user to efficiently determine the seating position.

According to a further advantageous configuration, the determination of the seating position of the user in the vehicle may comprise determining a seating position suggestion by means of the vehicle, transmitting the seating position suggestion from the vehicle to the mobile terminal, and providing a vehicle-specific seating position display on the mobile terminal, wherein the vehicle-specific seating position display provides the user with one or more seating positions in the vehicle, and wherein the determined seating position suggestion is visibly displayed to the user on the mobile terminal in the vehicle-specific seating position display. This makes it possible for the seating position in the vehicle to be efficiently determined by the vehicle and to be made available to the user.

According to a further advantageous configuration, the user can be logged in at the determined seating position suggestion for the vehicle by means of the vehicle, and/or the user can be logged in at the determined seating position suggestion for the vehicle by means of the vehicle if no manual changing of the seating position suggestion by the user is received by the vehicle within a predefined period of time. This makes it possible for the user to be logged in at the determined seating position in the vehicle in an automated manner.

According to a further advantageous configuration, the determination of the seating position of the user in the vehicle may comprise receiving an operating interaction of the user with the vehicle-specific seating position display, wherein the operating interaction is representative of the seating position suggestion being changed, and transmitting the changed seating position suggestion as the seating position of the user from the mobile terminal to the vehicle. This makes it possible for the user to efficiently change a seating position suggestion and therefore to efficiently control the log-in at the seating position in the vehicle.

According to a further advantageous configuration, the log-in of the user at the determined seating position in the vehicle by means of the vehicle may comprise the vehicle providing the mobile terminal belonging to the user with a log-in information message for logging in the user at the determined seating position in the vehicle, the mobile terminal receiving from the user a confirmation in response to the log-in information message for logging in the user at the determined seating position, transmitting the received confirmation from the mobile terminal to the vehicle, and logging in the user at the determined seating position in the vehicle by means of the vehicle after the user's confirmation has been received. This makes it possible to efficiently increase the security of the method. The user can be transparently informed about the log-in at the seating position and can confirm the log-in.

According to a further advantageous configuration, the log-in information message for logging in the user at the determined seating position may comprise an individual button of a graphical interface of the mobile terminal, with which the user can log in at the determined seating position in the vehicle. This makes it possible to efficiently simplify the log-in of the user at the seating position in the vehicle.

According to a further advantageous configuration, the confirmation may comprise an individual operating interaction of the user with the individual button of the graphical interface of the mobile terminal. This makes it possible to efficiently simplify the log-in of the user at the seating position.

According to a further advantageous configuration, the method may also comprise configuring the determined seating position in the vehicle, after the user has been logged in at the determined seating position, on the basis of a user-specific profile. This makes it possible to efficiently adapt vehicle-specific and/or seating-position-specific services to the logged-in user.

According to a further advantageous configuration, the wireless communication protocol may be Bluetooth Low Energy. This makes it possible for the vehicle to efficiently detect the mobile terminal.

According to a further aspect, the disclosure herein is distinguished by a computer-readable medium for logging a user into a vehicle, wherein the computer-readable medium comprises instructions which, when executed on a computer and/or a controller (which may be collectively referred to herein as “controllers”), carry out the method described above. Controllers include circuits (e.g., integrated circuits) that contain typical functionality of central processing units (CPU) and are configured to perform various calculations and analysis based on manufacturer programming instructions. One example of a controller used in vehicles is that of any of various Engine Control Units (ECNs), as well as any number of additional vehicle controllers as are commonly used by different manufacturers in modern automobiles.

According to a further aspect, the disclosure herein is distinguished by a system for logging a user into a vehicle, wherein the system is designed to carry out the method described above.

According to a further aspect, the disclosure herein is distinguished by a vehicle comprising the system described above for logging a user into a vehicle.

Further features of the disclosure emerge from the claims, the figures and the description of the figures. All features and combinations of features mentioned above in the description and the features and combinations of features mentioned below in the description of the figures and/or shown in the figures alone can be used not only in the respectively stated combination, but also in other combinations or alone.

### BRIEF DESCRIPTION OF THE DRAWINGS

A preferred exemplary embodiment of the disclosure is described below with reference to the accompanying drawings. Further details, preferred configurations and developments of the disclosure emerge therefrom. Specifically,

FIG. 1 schematically shows an exemplary method for logging a user into a vehicle,

FIG. 2 schematically shows an exemplary method for detecting a mobile terminal belonging to the user,

FIG. 3 schematically shows an exemplary method for determining a seating position of the user in the vehicle, and

FIG. 4 schematically shows an exemplary method for logging in the user at the determined seating position in the vehicle.

### DESCRIPTION

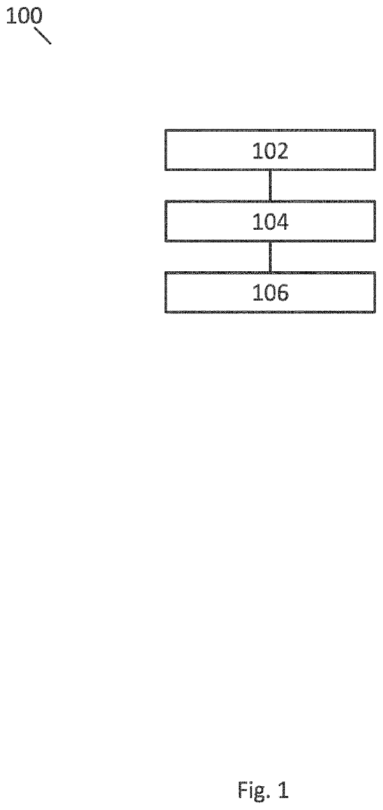

In detail, FIG. 1 shows an exemplary method 100 for logging a user into a vehicle. A user may enter a vehicle with a mobile terminal and may sit down on a seat inside the vehicle. The user can log in at the seating position by means of the mobile terminal and can therefore use and/or control one or more functions of the seating position in the vehicle and/or one or more functions of the vehicle. For example, the use and/or control of a function may comprise automated personalization of the function in response to user-specific requirements. Functions of the vehicle may be, for example, a sitting position, an air conditioning system function, a light color, a configuration of a digital media service of the vehicle, and/or a navigation function. The user can be logged in at the seating position using a single operating input by the user. For example, the operating input may be a gesture, a touch input and/or an input via a mechanical operating element of the mobile terminal.

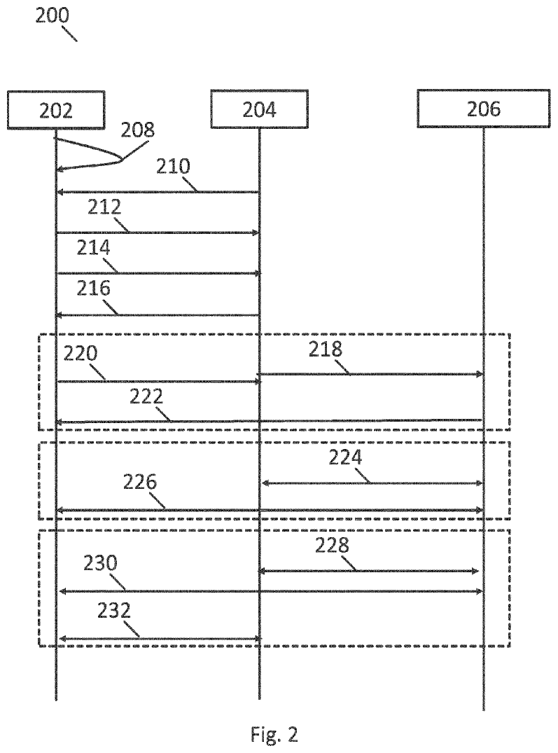

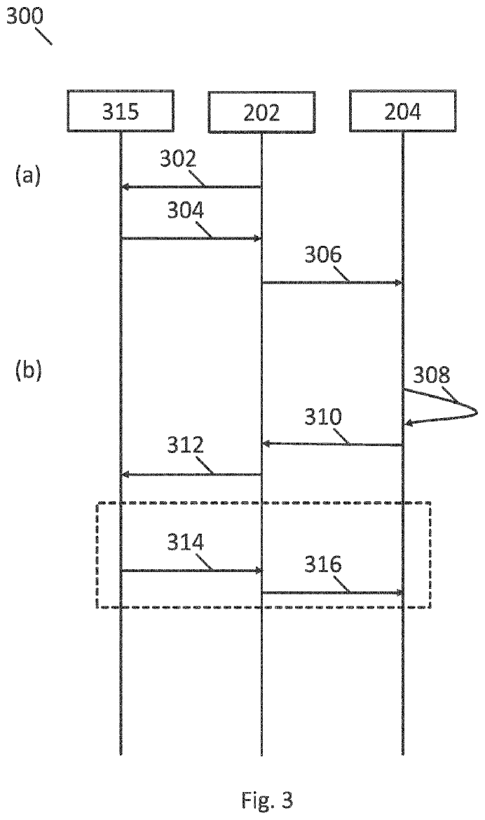

The method 100 can detect 102 a mobile terminal belonging to the user. An exemplary method for detecting 102 a mobile terminal belonging to the user is illustrated in FIG. 2. Furthermore, the method 100 can determine 104 a seating position of the user in the vehicle. An exemplary method for determining 104 a seating position of the user in the vehicle is illustrated in FIG. 3. The detection 102 of the mobile terminal belonging to the user and the determination 104 of the seating position of the user may be carried out sequentially or in parallel. The detection 102 of the mobile terminal is preferably carried out in parallel with the determination 104 of the seating position. Alternatively, the mobile terminal may already be detected outside the vehicle. As a further alternative, the mobile terminal is detected only when the user occupies a seating position in the vehicle.

The method 100 may provide the mobile terminal belonging to the user with a message from the vehicle for logging in the user at the determined seating position in the vehicle, also called log-in information message. For example, the message for logging in the user may be provided in an app or a widget on the mobile terminal. The message may comprise a button or another control for logging in the user at the seating position in the vehicle. A confirmation or a confirmation message for logging in the user at the determined seating position may be received from the user by the mobile terminal. For example, the confirmation or the confirmation message may comprise pressing the button or another interaction with another control that was displayed to the user on the mobile terminal. The received confirmation or confirmation message can be transmitted from the mobile terminal to the vehicle.

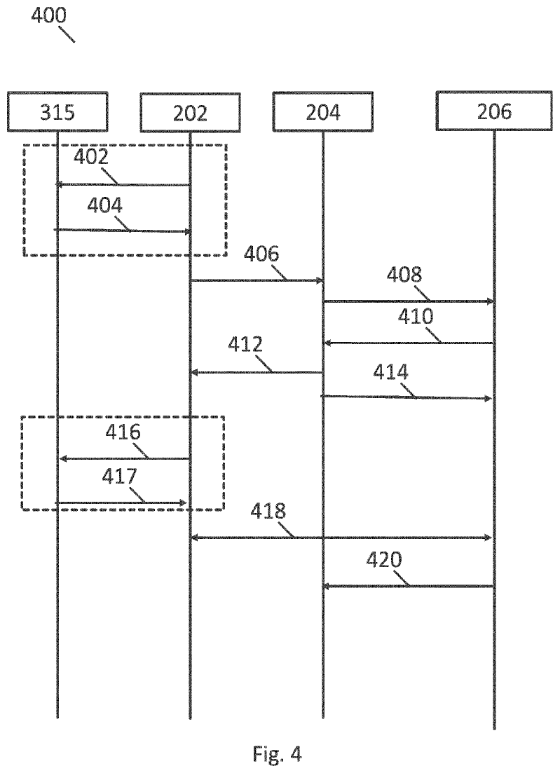

The method 100 can log in 106 the user at the determined seating position in the vehicle by means of the vehicle. An exemplary method for logging in the user at the determined seating position is shown in FIG. 4. For example, the user can be logged in by means of the vehicle, after the confirmation or the confirmation message has been received, at the determined seating position in the vehicle. After the user has been logged in 106, the vehicle can provide the logged-in user with functions and/or services in a personalized manner, in particular at the seating position of the user in the vehicle.

The method 100 can store the logged-in user in the vehicle. If the mobile terminal belonging to the stored user is detected by the vehicle, the user can be logged in in an automated manner at the seating position without the user interacting with the mobile terminal. Alternatively, the method 100 can log out the user in an automated manner if the user leaves the seating position in the vehicle and exits the vehicle.

In detail, FIG. 2 shows an exemplary method 200 for detecting 102 a mobile terminal 202 belonging to the user. The mobile terminal 202 may execute a mobile application, also called app below, which detects the mobile terminal in communication with a vehicle 204 and/or a backend server 206. The mobile application can be executed on the mobile terminal in the background. The mobile application is preferably an application belonging to the vehicle manufacturer, which makes it possible to use and/or control vehicle functions and vehicle-specific backend functions. The communication between the mobile terminal 202 and the vehicle 204 can be carried out via a wireless communication interface, preferably Bluetooth and/or Bluetooth Low Energy. The communication between the mobile terminal 202 and the backend server 206, and between the vehicle 204 and the backend server 206, can be carried out via a mobile radio communication interface, for example.

The mobile terminal 202 may scan 208 a predefined log-in service. The scanning 208 may be carried out continuously by the mobile terminal 202. For example, the scanning may be carried out as a background service on the mobile terminal. The vehicle 204 may provide 210 the predefined log-in service. A transmission power of an antenna of the vehicle, for example a Bluetooth antenna of the vehicle, can be reduced when providing the predefined log-in service. A reception range of the predefined log-in service can be restricted by reducing the transmission power. This makes it possible to efficiently increase the security against unwanted access to the log-in service provided. The transmission power of the antenna of the vehicle is preferably selected such that the predefined log-in service can be received only inside the vehicle. Furthermore, the transmission power may be statically determined on the basis of a vehicle type, with the result that no unauthorized user outside the vehicle can receive the predefined log-in service. The mobile terminal 202 may detect 212 the log-in service provided and may connect 214 to the vehicle. The vehicle may provide 216 the mobile terminal with parameters. For example, the parameters may be provided or made available via a GATT server. The mobile terminal can use the parameters provided to request data from the vehicle and to transmit data from the mobile terminal to the vehicle. Furthermore, the parameters may be readable and/or writable, depending on the parameter. Writing a writable parameter by way of an app of the mobile terminal makes it possible to write the corresponding parameter of the GATT server. Writing the writable parameter means that the parameter is transmitted from the app of the mobile terminal to the GATT server. Reading a readable parameter by way of the app of the mobile terminal makes it possible for the readable parameter to be transmitted from the GATT server to the app of the mobile terminal.

For example, the vehicle may provide the mobile terminal with the following parameters:

TABLE 1
exemplary parameters which are made available to the mobile terminal
by the vehicle in order to transmit data from the mobile terminal
to the vehicle and from the vehicle to the mobile terminal.

| Parameter | Description |
|---|---|
| Identifier of the | Unique identifier which identifies the |
| log-in service | log-in service; the vehicle provides |
| | the log-in service with the unique |
| | identifier; the mobile terminal scans |
| | the log-in service with the unique |
| | identifier; |
| Public vehicle | The public vehicle identifier may be |
| identifier | used for secure device validation of |
| | the log-in service provided; for |
| | example, the public vehicle identifier |
| | may be a random UUID. For |
| | example, the public vehicle identifier |
| | may be changed each time the log-in |
| | service is provided. |
| User code | Transmit a user code from the |
| | vehicle to the mobile terminal; the |
| | user code can be used to |
| | authenticate the user. |
| Uniform Resource | Transmit a URI from the vehicle to |
| Identifier (URI) | the mobile terminal; the URI can be |
| | used to authenticate the user. |
| Sitting position | Provide the mobile terminal with a |
| suggestion | sitting position suggestion from the |
| | vehicle |
| Sitting position | Transmit a selected sitting position |
| selection | from the mobile terminal to the |
| | vehicle |
| Log-in request | Parameter for triggering the process |
| confirmation | of logging the user into the vehicle |
| | by way of the mobile terminal. |

Steps 218 to 222 can be optionally carried out in order to increase the security when detecting 102 the mobile terminal. In step 218, the vehicle 204 can generate a public vehicle identifier and transmit it to the backend server 206. The public vehicle identifier can be generated by the vehicle if the vehicle provides a mobile terminal with the log-in service. Furthermore, the vehicle can newly generate the public vehicle identifier if the log-in service is made available to a mobile terminal again. This makes it possible to prevent tracking of provided log-in services and to improve the privacy of the method 200. In addition, it is possible to prevent the mobile terminal from communicating with unknown devices, for example unknown vehicles, which provide a log-in service that does not correspond to the log-in service of the vehicle in which the user has taken up a seating position.

In step 220, the mobile terminal 202 can request the public vehicle identifier from the vehicle. The mobile terminal can then have the public vehicle identifier checked 222 by the backend server 206. The backend server 206 may transmit a result of the check to the mobile terminal. If the result of the check is that the public vehicle identifier is valid, the mobile terminal can set up a preferably secure connection to the vehicle and, in particular, to the log-in service of the vehicle. If the result of the check is that the public vehicle identifier is not valid, the mobile terminal can abort the method with the log-in service and can scan for a further log-in service.

Furthermore, steps 218 to 220 can be used to request vehicle-specific information as additional log-in information. For example, a vehicle type, a number of seats, a color of the vehicle, color of the vehicle seats and/or further details specific to the vehicle interior can be requested.

Steps 224 and 226 are optional and form a first possible way of setting up a secure communication connection between the mobile terminal and the vehicle. Steps 224 and 226 can be used to set up a secure indirect communication connection between the mobile terminal and the vehicle. For this purpose, a secure communication connection can be set up 224 between the mobile terminal 202 and the backend server 206 and a secure communication connection can be set up 226 between the backend server and the vehicle. The communication between the mobile terminal and the vehicle can be carried out only indirectly via the backend server. An already existing secure communication connection between an app of the mobile terminal and the backend server can be used for this purpose, for example. The secure indirect communication connection has the advantage that attacks on the wireless interface between the mobile terminal and the vehicle are prevented. For example, local BLE attacks can be prevented by the secure indirect communication connection. The secure direct and/or the secure indirect communication connections can be used in the further steps of the method to securely exchange data. This makes it possible to efficiently increase the security when exchanging the subsequent data.

Steps 228 and 230 are optional and form a second possible way of setting up a secure connection between the mobile terminal and the vehicle. Steps 228 and 230 enable a secure direct communication connection between the mobile terminal and the vehicle. In step 228, the vehicle exchanges security data, for example cryptographic keys and/or security certificates, with the mobile terminal via the backend server in order to set up a secure direct communication channel. In step 230, the mobile terminal exchanges security data, for example cryptographic keys and/or security certificates, with the vehicle via the backend server in order to set up a secure direct communication channel. For example, a secure BLE communication channel can be set up between the mobile terminal and the vehicle using the security data exchanged via the backend server.

In detail, FIG. 3 shows an exemplary method 300 for determining 104 a seating position of the user in the vehicle. The exemplary method 300 shown in FIG. 3 may determine a seating position of the user manually, variant (a), or on the basis of a seating position suggestion, variant (b).

In variant (a), the mobile terminal 202 may provide 302 a user 315 of the mobile terminal 202 with a vehicle-specific seating position display. The vehicle-specific seating position display may display an arrangement of seating positions in a vehicle. The arrangement of seating positions in the vehicle may be transmitted from the vehicle 204 and/or the backend server 206 to the mobile terminal, for example in steps 218 to 222. The mobile terminal 202 may receive 304 an operating interaction of the user 315 with the vehicle-specific seating position display, wherein the operating interaction is representative of a seating position in the vehicle that is selected by the user. The selected seating position of the user 315 can be transmitted 306 from the mobile terminal 202 to the vehicle 204. The secure direct communication connection or the secure indirect communication connection, for example, can be used to transmit the selected seating position. The selected seating position can therefore be securely transmitted to the vehicle.

In variant (b), the vehicle 204 may determine 308 a seating position suggestion. The seating position suggestion may be determined using sensor data from the vehicle and/or an occupant model of the vehicle. Exemplary sensor data may be: seating position occupancy, sensor data relating to the opening and/or closing of doors of the vehicle, belt status and/or a camera-based interior detection of occupants. Furthermore, historical data relating to the seating position occupancy of detected occupants can be used. The seating position suggestion may be determined in a rule-based manner using the sensor data and/or historical data.

Examples of rules for determining a seating position suggestion are:
If only the driver's seat is occupied, the driver's seat is determined as the seating position suggestion.
If the driver's seat and the passenger seat are occupied and the driver has not opened the driver's door in the last five minutes, the passenger seat is determined as the seating position suggestion.
If all seats are occupied and all doors have been opened, but the user wishing to log in has sat on the rear right-hand seat the last four times, the rear right-hand seat is determined as the seating position suggestion.

The vehicle 204 can transmit 310 the seating position suggestion from the vehicle 204 to the mobile terminal 202. The mobile terminal 202 can provide 312 the user 315 with a vehicle-specific seating position display with the determined seating position suggestion on the mobile terminal. The vehicle-specific seating position display may provide the user with one or more seating positions in the vehicle. Furthermore, the determined seating position suggestion can be visibly displayed to the user on the mobile terminal in the vehicle-specific seating position display. The arrangement of seating positions in the vehicle on the vehicle-specific seating position display may be transmitted from the vehicle 204 and/or the backend server 206 to the mobile terminal 202, for example in steps 218 to 222.

Steps 314 and 316 may be optionally carried out. In step 314, the mobile terminal 202 may receive an operating interaction of the user 315 with the vehicle-specific seating position display, wherein the operating interaction is representative of the seating position suggestion being changed. In step 316, the changed seating position suggestion can be transmitted as the selected seating position of the user 315 from the mobile terminal 202 to the vehicle 204. As a result, the user 315 can easily change a seating position suggestion even if it is determined in an automated manner.

In detail, FIG. 4 shows an exemplary method 400 for logging in 106 the user at the determined seating position in the vehicle. Before the method 400 is carried out, the user has already logged into the app of the mobile terminal. If the user has not logged into the app of the mobile terminal, the user must first of all log into the app of the mobile terminal in order to be authenticated with respect to the backend server. After the user has successfully logged into the app of the mobile terminal, the user can carry out the method 400. After the sitting position of the user has been determined, the method 400 can log the user into the vehicle. In order to log in the user, the mobile terminal can provide 402 the user with a notification message for logging in the user at the determined seating position in the vehicle. The notification message may comprise a log-in suggestion and/or a suggested seating position in the vehicle. The user can confirm 404 the notification message for logging in the user at the determined seating position in the vehicle. Steps 402 and 404 are optional and can increase the security of the method 400 by virtue of the user having to confirm the log-in process. Alternatively, the user can be logged in at the determined seating position in an automated manner without confirmation by the user. Steps 402 and 404 are not carried out when the user is logged in in an automated manner. The vehicle can log in the user by means of a standardized authentication and authorization method in the vehicle. For example, the vehicle can log in the user using OpenID Connect and/or the oauth 2.0 Device Authorization Grant standard.

In step 406, the mobile terminal 202 can transmit 406 a message for registering the user code and/or URI parameters to the vehicle. When the user code and/or URI parameters have been registered by the mobile terminal, the mobile terminal can receive the user code and/or the URI from the vehicle in an automated manner. In step 408, the vehicle 204 can transmit a client identifier of the vehicle to the backend server 206. Transmitting the client identifier from the vehicle 204 to the backend server 206 makes it possible for the vehicle 204 to request access from the backend server. In response to the transmission 408 of the client identifier, the backend server 206 can transmit 410 a device code, the user code and the URI, in particular a URI for verification by the user, to the vehicle. Steps 408 and 410 can be carried out in a similar manner to steps (A) and (B) of the oauth 2.0 Device Authorization Grant standard. The oauth 2.0 Device Authorization Grant standard is published as RFC 8628. The process of the oauth 2.0 Device Authorization Grant standard is shown in FIG. 1 of RFC 8628. In addition, the message may comprise the log-in request confirmation parameter which triggers the process of logging the user into the vehicle. In step 412, the user code and the URI can be transmitted from the vehicle 204 to the mobile terminal 202. Step 412 can be carried out in a similar manner to step (C) of the oauth 2.0 Device Authorization Grant standard. In contrast to step (D) of the oauth 2.0 Device Authorization Grant standard, the user code and the URI can be transmitted in an automated manner from the vehicle 204 to the mobile terminal 202 using the user code and URI parameters. The parameters are preferably transmitted from the vehicle 204 to the mobile terminal 202 using the first wireless communication protocol. For example, the first wireless communication protocol is Bluetooth Low Energy. Alternatively, only the user code can be transmitted from the vehicle 204 to the mobile terminal 202 in step 412 and the URI can be transmitted from the backend server 206 to the mobile terminal. For example, the URI may be transmitted from the backend server to the mobile terminal using a mobile radio communication protocol. This makes it possible to increase the security of the transmission of the user code and the URI.

Furthermore, in contrast to step (D) of the oauth 2.0 Device Authorization Grant standard, a user with a web browser can be dispensed with in step 412. An app which automates the user with the web browser can be executed on the mobile terminal. A QR code scan for transmitting the user code and the URI may likewise be dispensed with. As described above, these data may be transmitted in an automated manner from the vehicle to the mobile terminal and in particular to the app of the mobile terminal using the first wireless communication protocol and with the registration of the user code and URI parameters of the log-in service.

In step 414, the vehicle 204 can transmit the device code from the backend server 206 and can transmit the client identifier to the backend server at cyclical intervals in order to query whether the user has confirmed log-in to the vehicle. Step 414 can be carried out in a similar manner to step (E) of the oauth 2.0 Device Authorization Grant standard.

In addition, the mobile terminal may provide 416 the user of the mobile terminal with a confirmation message for confirming the log-in request and may receive 417 a response message to the confirmation message from the user of the mobile terminal. As described above, the confirmation message may comprise the seating position of the user that was determined in step 104. With the response to the confirmation request, the user can confirm the log-in of the user and the seating position of the user in the vehicle.

The mobile terminal can respond 418 in an automated manner to the log-in request received in step 412. Step 418 can be carried out in a similar manner to step (D) of the oauth 2.0 Device Authorization Grant standard. In contrast to step (D) of the oauth 2.0 Device Authorization Grant standard, confirmation by the user is optional. The mobile terminal can authorize the log-in request in an automated manner. Furthermore, the mobile terminal can confirm the seating position in an automated manner. The user can therefore be logged in at the seating position in the vehicle in a completely automated manner. In addition, before responding 418 to the received log-in request, the mobile terminal can determine a distance between the mobile terminal as the receiver and the vehicle as the transmitter. The mobile terminal as the receiver can read a transmission power of the vehicle as the transmitter. For this purpose, a parameter of the transmission power of the transmitter can be set to be readable by the receiver, for example. The receiver measures the reception power. The receiver can calculate a distance between the transmitter and the receiver from a difference between the transmission power of the transmitter and the reception power of the receiver. If the calculated distance exceeds a predefined distance threshold value, the mobile terminal aborts the method for logging in the user. Otherwise, the mobile terminal continues the method for logging in the user. The mobile terminal responds to the received log-in request. This makes it possible to prevent mobile terminals outside the vehicle from being able to log into the vehicle, in particular at a seating position in the vehicle.

In step 420, the backend server 206 can validate the device code of the vehicle and can transmit 420 an access token to the vehicle if the mobile terminal or the user of the mobile terminal has confirmed access. If the mobile terminal or the user of the mobile terminal has not confirmed access, the backend server can transmit an error message to the vehicle and/or can transmit a message to the vehicle to continue the cyclic querying 414. Step 420 can be carried out in a similar manner to step (F) of the oauth 2.0 Device Authorization Grant standard.

The method 100 can advantageously carry out automatic logging into a vehicle. Furthermore, the method 100 can provide an automatic log-in suggestion for a seating position in a vehicle on a mobile terminal without the need to manually trigger the log-in process. The user of the vehicle can be automatically logged into the vehicle or must carry out only a single operating interaction in order to log in at a seating position in the vehicle. Log-in information relating to the user need not be stored in the vehicle. It is also no longer necessary to scan a QR code order to log the user into the vehicle. The user can also efficiently log in at seating positions in the vehicle which do not have a display. Furthermore, a plurality of users of the vehicle can log in in a parallel manner at their respective seating position by means of the method without the need for a display at each seating position.

### LIST OF REFERENCE SIGNS

100 Method
102 Detect a mobile terminal
104 Determine a seating position
106 Log in a user
200 Method
202 Mobile terminal
204 Vehicle
206 Backend server
208 Scan a log-in service
210 Provide a log-in service
212 Detect a log-in service
214 Connect to the vehicle
216 Provide parameters
218 Generate and transmit public vehicle identifiers
220 Request the public vehicle identifier
222 Check the public vehicle identifier
224 Set up a secure communication connection
226 Clear a secure communication connection
228 Exchange security data
230 Exchange security data
232 Set up a secure communication connection
300 Method
302 Provide a seating position display
304 Receive a selected seating position
306 Transmit the selected seating position
308 Determine a seating position suggestion
310 Transmit the seating position suggestion
312 Provide a seating position suggestion and a vehicle-specific seating position display
314 Receive an operating input
315 User
316 Transmit a changed seating position
400 Method
402 Provide a log-in suggestion
404 Confirm the log-in suggestion
406 Register parameters
408 Transmit a client identifier
410 Transmit a device code, a user code and a URI
412 Transmit a user code and a URI
414 Transmit a device code and a client identifier
416 Provide a confirmation message
417 Receive a response message
418 Respond to the log-in request
420 Transmit an access token

1.-13. (canceled)

14. A method for logging a user into a vehicle, the method comprising:
detecting a mobile terminal belonging to the user, wherein the mobile terminal belonging to the user is detected using a wireless communication protocol;
determining a seating position of the user in the vehicle; and
logging in the user at the determined seating position in the vehicle by means of the vehicle.

15. The method as claimed in claim 14, wherein the determination of the seating position of the user in the vehicle comprises:
providing a vehicle-specific seating position display on the mobile terminal, wherein the vehicle-specific seating position display provides the user with one or more seating positions in the vehicle;
receiving an operating interaction of the user with the vehicle-specific seating position display, wherein the operating interaction is representative of a seating position in the vehicle that is selected by the user; and
transmitting the selected seating position from the mobile terminal to the vehicle.

16. The method as claimed in claim 14, wherein the determination of the seating position of the user in the vehicle comprises:
determining a seating position suggestion by means of the vehicle;
transmitting the seating position suggestion from the vehicle to the mobile terminal;
providing a vehicle-specific seating position display on the mobile terminal, wherein the vehicle-specific seating position display provides the user with one or more seating positions in the vehicle, and
wherein the determined seating position suggestion is visibly displayed to the user on the mobile terminal in the vehicle-specific seating position display.

17. The method as claimed in claim 14, wherein the user is logged in at the determined seating position suggestion for the vehicle by means of the vehicle; and
wherein the user is logged in at the determined seating position suggestion for the vehicle by means of the vehicle when no manual changing of the seating position suggestion by the user is received by the vehicle within a predefined period of time.

18. The method as claimed in claim 14, wherein the determination of the seating position of the user in the vehicle comprises:
receiving an operating interaction of the user with the vehicle-specific seating position display, wherein the operating interaction is representative of the seating position suggestion being changed; and
transmitting the changed seating position suggestion as the seating position of the user from the mobile terminal to the vehicle.

19. The method as claimed in claim 14, wherein the logging-in of the user at the determined seating position in the vehicle by means of the vehicle comprises:
the vehicle providing the mobile terminal belonging to the user with a log-in information message for logging in the user at the determined seating position in the vehicle;
the mobile terminal receiving from the user a confirmation in response to the log-in information message for logging in the user at the determined seating position;
transmitting the received confirmation from the mobile terminal to the vehicle; and
logging in the user at the determined seating position in the vehicle by means of the vehicle after the user's confirmation has been received.

20. The method as claimed in claim 19, wherein the log-in information message comprises an individual button of a graphical interface of the mobile terminal, with which the user can log in at the determined seating position in the vehicle.

21. The method as claimed in claim 20, wherein the confirmation comprises an individual operating interaction of the user with the individual button of the graphical interface of the mobile terminal.

22. The method as claimed in claim 14, the method also comprising:
configuring the determined seating position in the vehicle, after the user has been logged in at the determined seating position, on the basis of a user-specific profile.

23. The method as claimed in claim 14, wherein the wireless communication protocol is Bluetooth Low Energy.

24. A computer-readable medium for logging a user into a vehicle, wherein the computer-readable medium comprises instructions which, when executed on controller, cause the controller to:
detect a mobile terminal belonging to the user, wherein the mobile terminal belonging to the user is detected using a wireless communication protocol;
determine a seating position of the user in the vehicle; and
log in the user at the determined seating position in the vehicle by means of the vehicle.

25. The computer-readable medium as claimed in claim 24, wherein determination of the seating position of the user in the vehicle comprises:
providing a vehicle-specific seating position display on the mobile terminal, wherein the vehicle-specific seating position display provides the user with one or more seating positions in the vehicle;
receiving an operating interaction of the user with the vehicle-specific seating position display, wherein the operating interaction is representative of a seating position in the vehicle that is selected by the user; and
transmitting the selected seating position from the mobile terminal to the vehicle.

26. The computer-readable medium as claimed in claim 24, wherein the determination of the seating position of the user in the vehicle comprises:
determining a seating position suggestion by means of the vehicle;
transmitting the seating position suggestion from the vehicle to the mobile terminal;
providing a vehicle-specific seating position display on the mobile terminal, wherein the vehicle-specific seating position display provides the user with one or more seating positions in the vehicle, and
wherein the determined seating position suggestion is visibly displayed to the user on the mobile terminal in the vehicle-specific seating position display.

27. The computer-readable medium as claimed in claim 24, wherein the user is logged in at the determined seating position suggestion for the vehicle by means of the vehicle; and
wherein the user is logged in at the determined seating position suggestion for the vehicle by means of the vehicle when no manual changing of the seating position suggestion by the user is received by the vehicle within a predefined period of time.

28. The computer-readable medium as claimed in claim 24, wherein the determination of the seating position of the user in the vehicle comprises:
receiving an operating interaction of the user with the vehicle-specific seating position display, wherein the operating interaction is representative of the seating position suggestion being changed; and
transmitting the changed seating position suggestion as the seating position of the user from the mobile terminal to the vehicle.

29. The method as claimed in claim 24, wherein the logging-in of the user at the determined seating position in the vehicle by means of the vehicle comprises:
the vehicle providing the mobile terminal belonging to the user with a log-in information message for logging in the user at the determined seating position in the vehicle;
the mobile terminal receiving from the user a confirmation in response to the log-in information message for logging in the user at the determined seating position;
transmitting the received confirmation from the mobile terminal to the vehicle; and
logging in the user at the determined seating position in the vehicle by means of the vehicle after the user's confirmation has been received.

30. The computer-readable medium as claimed in claim 29, wherein the log-in information message comprises an individual button of a graphical interface of the mobile terminal, with which the user can log in at the determined seating position in the vehicle, and wherein the confirmation comprises an individual operating interaction of the user with the individual button of the graphical interface of the mobile terminal.

31. A vehicle comprising:
a seat;
a mobile terminal with a seating position display; and
a controller configured to:
detect a mobile terminal belonging to a user of the vehicle, wherein the mobile terminal belonging to the user is detected using a wireless communication protocol;
determine a seating position of the seat in the vehicle; and
log in the user at the determined seating position in the vehicle by means of the vehicle.

32. The vehicle of claim 31 wherein the controller is configured to determine the seating position of the user in the vehicle by:
providing a vehicle-specific seating position display on the mobile terminal, wherein the vehicle-specific seating position display provides the user with one or more seating positions in the vehicle;
receiving an operating interaction of the user with the vehicle-specific seating position display, wherein the operating interaction is representative of a seating position in the vehicle that is selected by the user; and
transmitting the selected seating position from the mobile terminal to the vehicle.

33. The vehicle of claim 31 wherein the controller is configured to determine the seating position of the in the vehicle by:
determining a seating position suggestion by means of the vehicle;
transmitting the seating position suggestion from the vehicle to the mobile terminal;
providing a vehicle-specific seating position display on the mobile terminal, wherein the vehicle-specific seating position display provides the user with one or more seating positions in the vehicle, and
wherein the determined seating position suggestion is visibly displayed to the user on the mobile terminal in the vehicle-specific seating position display.
